(19) United States
(12) Patent Application Publication
(10) Pub. No.: US 2018/0203990 A1
(43) Pub. Date: Jul. 19, 2018

(54) INFORMATION PROCESSING SYSTEM, INFORMATION PROCESSING METHOD, AND COMPUTER READABLE MEDIUM

(71) Applicant: MITSUBISHI ELECTRIC CORPORATION, Tokyo (JP)

(72) Inventors: Kazumi SAITO, Tokyo (JP); Nori MATSUDA, Tokyo (JP); Takashi ITO, Tokyo (JP); Tadakazu YAMANAKA, Tokyo (JP); Mitsuhiro HATTORI, Tokyo (JP); Sachihiro ICHIKAWA, Tokyo (JP); Yoichi SHIBATA, Tokyo (JP); Takumi MORI, Tokyo (JP); Takato HIRANO, Tokyo (JP)

(73) Assignee: MITSUBISHI ELECTRIC CORPORATION, Tokyo (JP)

(21) Appl. No.: 15/743,782

(22) PCT Filed: Sep. 11, 2015
(86) PCT No.: PCT/JP2015/075850

§ 371 Date: Jan. 11, 2018

(51) Int. Cl. G06F 21/36; G06F 21/32; G06F 21/60; H04L 29/06

(52) U.S. Cl. CPC G06F 21/36; G06F 21/32; H04L 63/08; G06F 21/604; G06F 21/602

(57) ABSTRACT

A database (7) stores a first identifier and visiting destination authentication information in association with each other, the first identifier being generated from visitor authentication information which is one of an encrypted face photograph image and key data used for generating the encrypted face photograph image, the visiting destination authentication information being the other of the encrypted face photograph image and the key data. An authentication terminal apparatus (9) receives authentication data from a mobile terminal device (2) used by a visitor (1) who intends to enter a facility and generates a second identifier from the authentication data in the same generation procedure as that of the first identifier. A server apparatus (6) searches the database (7) for visiting destination authentication information associated with a first identifier matching the second identifier, and acquires from the database (7), the visiting destination authentication information associated with the first identifier matching the second identifier, when the authentication data is the visitor authentication information. The authentication terminal apparatus (9) decrypts the visiting destination authentication information acquired by the server apparatus (6) using the authentication data being the visitor authentication information, and obtains the face photograph image.

### TECHNICAL FIELD

The present invention relates to authentication using a face photograph image.

### BACKGROUND ART

As a conventional authentication method using a face photograph image, there is a method described in Patent Literature 1.

In the authentication method of Patent Literature 1, a face photograph image of a visitor is registered in advance in a database by a gateway management system. An ID (Identifier) tag associated with the face photograph image is passed to the visitor.

When the visitor enters a facility, the gateway management system reads the ID tag carried by the visitor. The face photograph image associated with the ID tag is retrieved from the database. The retrieved face photograph image is displayed.

Meanwhile, a face photograph image of the visitor photographed with a camera is also displayed.

Then, a guard performs authentication by comparing the two face photograph images displayed.

### CITATION LIST

### Patent Literature

Patent Literature 1: JP2014-038492A

### SUMMARY OF INVENTION

### Technical Problem

In the authentication method according to Patent Literature 1, it is necessary to store the face photograph image of the visitor in the database for a long period of time.

Therefore, there is a security risk that the face photograph image leaks out due to a hacking or a virus attack to the system.

Also, storing the face photograph image of the visitor in the database which is not under a control of the visitor is undesirable in view of a protection of privacy of a visitor.

The present invention mainly aims to realize safe face authentication which takes care of privacy of a visitor.

### Solution to Problem

A information processing system according to the present is connected to a database for storing a first identifier and visiting destination authentication information in association with each other, the first identifier being generated from visitor authentication information which is one of an encrypted face photograph image encrypted using key data and the key data, the visiting destination authentication information being the other of the encrypted face photograph image and the key data.

The information processing system may include:

an authentication data reception unit to receive authentication data from a visitor terminal apparatus used by a visitor who intends to enter a facility;

a second identifier generation unit to generate a second identifier from the authentication data in the same generation procedure as that of the first identifier;

a search unit to search for visiting destination authentication information associated with the first identifier matching the second identifier, and acquire from the database, the visiting destination authentication information associated with the first identifier matching the second identifier, when the authentication data is the visitor authentication information; and

a decryption unit to obtain the face photograph image by a decryption using the visiting destination authentication information acquired by the search unit and the authentication data being the visitor authentication information.

### Advantageous Effects of Invention

In the present invention, authentication is performed without storing a face photograph image of a visitor in a database, using the face photograph image.

Therefore, the face photograph image of the visitor does not leak out.

For this reason, according to the present invention, it is possible to realize safe face authentication which takes care of privacy of the visitor.

### BRIEF DESCRIPTION OF DRAWINGS

FIG. 1 is a diagram illustrating an example of a configuration of an authentication system according to a first embodiment and a second embodiment;

FIG. 2 is a diagram illustrating an example of a functional configuration of an acceptance terminal apparatus according to the first embodiment and the second embodiment;

FIG. 3 is a diagram illustrating an example of a functional configuration of a server apparatus according to the first embodiment and the second embodiment;

FIG. 4 is a diagram illustrating an example of a functional configuration of a reading apparatus and an authentication terminal apparatus according to the first embodiment and the second embodiment;

FIG. 5 is a flow chart diagram illustrating an example of an operation at a time of registration according to the first embodiment and the second embodiment; and

FIG. 6 is a flow chart diagram illustrating an example of an operation at a time of authentication according to the first embodiment and the second embodiment.

### DESCRIPTION OF EMBODIMENTS

### First Embodiment

Explanation of Configuration

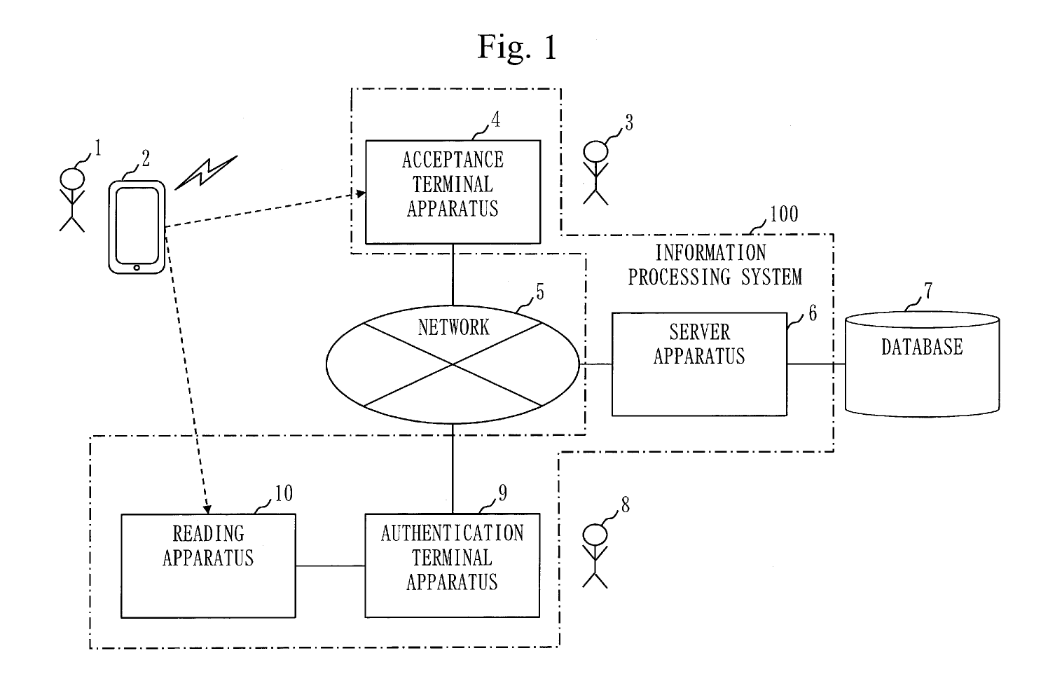

FIG. 1 illustrates an example of a configuration of an authentication system according to the present embodiment.

In FIG. 1, a visitor 1 is a person who visits a facility for which face authentication is required.

The visitor 1 is also referred to as a prospective visitor 1, at a phase before visiting the facility, specifically at a phase of accessing an acceptance terminal apparatus 4 described later in an attempt to visit the facility.

A mobile terminal device 2 is a mobile terminal device equipped with a camera used by the visitor 1.

The mobile terminal device 2 communicates with the acceptance terminal apparatus 4 and a reading apparatus 10 to be described later.

The mobile terminal device 2 is specifically, a smartphone, a mobile phone, a tablet terminal, a wearable terminal, and the like.

The mobile terminal device 2 corresponds to an example of a prospective visitor terminal apparatus and a visitor terminal apparatus.

An acceptance responsible person 3 is a person who accepts the visitor 1 to the facility.

The acceptance responsible person 3 is a person belonging to the facility.

An acceptance terminal apparatus 4 is a terminal apparatus used by the acceptance responsible person 3 in an acceptance procedure of the visitor 1.

A network 5 is an internal network of the facility that is a visiting destination. The acceptance terminal apparatus 4, a server apparatus 6 and an authentication terminal apparatus 9 to be described later are connected to the network 5.

The server apparatus 6 is a server apparatus for operating a database 7 which stores information necessary for face authentication of the visitor 1.

The database 7 stores a first identifier and visiting destination authentication information in association with each other, the first identifier being generated from visitor authentication information.

The visitor authentication information is key data or an encrypted face photograph image which is a face photograph image of the prospective visitor 1 encrypted using the key data.

The key data used for encrypting the face photograph image of the prospective visitor 1 is, for example, a random number.

In addition to the random number, as the key data, a fixed value, a personal identifier, a password, and etc. may be used.

The visiting destination authentication information is the encrypted face photograph image or the key data.

In the present embodiment, the visitor authentication information is the key data, more specifically, the random number.

In the present embodiment, the visiting destination authentication information is the encrypted face photograph image.

In the present embodiment, the face photograph image is encrypted according to common key encryption algorithms such as AES (Advanced Encryption Standard), Camellia and so on.

Therefore, the key data is an encryption key for encrypting the face photograph image and a decryption key for decrypting the encrypted face photograph image.

A guard 8 is a person who authenticates the visitor 1 at an entrance of a visiting destination.

An authentication terminal apparatus 9 is a terminal apparatus used by the guard 8 for authentication of the visitor 1.

The reading apparatus 10 is a device connected to the authentication terminal apparatus 9 and reads authentication data from the mobile terminal device 2 of the visitor 1.

The authentication data is data used for authentication of the visitor 1.

As described later, the visitor authentication information is transmitted from the acceptance terminal apparatus 4 to the mobile terminal device 2 of the prospective visitor 1, if the encrypted face photograph image of the prospective visitor 1 has been registered as the visiting destination information in the server apparatus 6 by the acceptance terminal apparatus 4.

If the mobile terminal device 2 has received the visitor authentication information from the acceptance terminal apparatus 4 when registering the encrypted face photograph image, the visitor authentication information is transmitted as the authentication data from the mobile terminal device 2 to the reading apparatus 10 when the visitor 1 visits the facility.

As described above, when the visitor 1 whose encrypted face photograph image is registered in the server apparatus 6 visits the facility, the reading apparatus 10 reads the visitor authentication as the authentication data from the mobile terminal device 2 of the visitor 1.

The acceptance terminal apparatus 4, the server apparatus 6, the authentication terminal apparatus 9 and the reading apparatus 10 constitute an information processing system.

In FIG. 1, the acceptance terminal apparatus 4, the server apparatus 6, the authentication terminal apparatus 9 and the reading apparatus 10 are different apparatuses. However, the acceptance terminal apparatus 4, the server apparatus 6, the authentication terminal apparatus 9 and the reading apparatus 10 may be realized by a single computer.

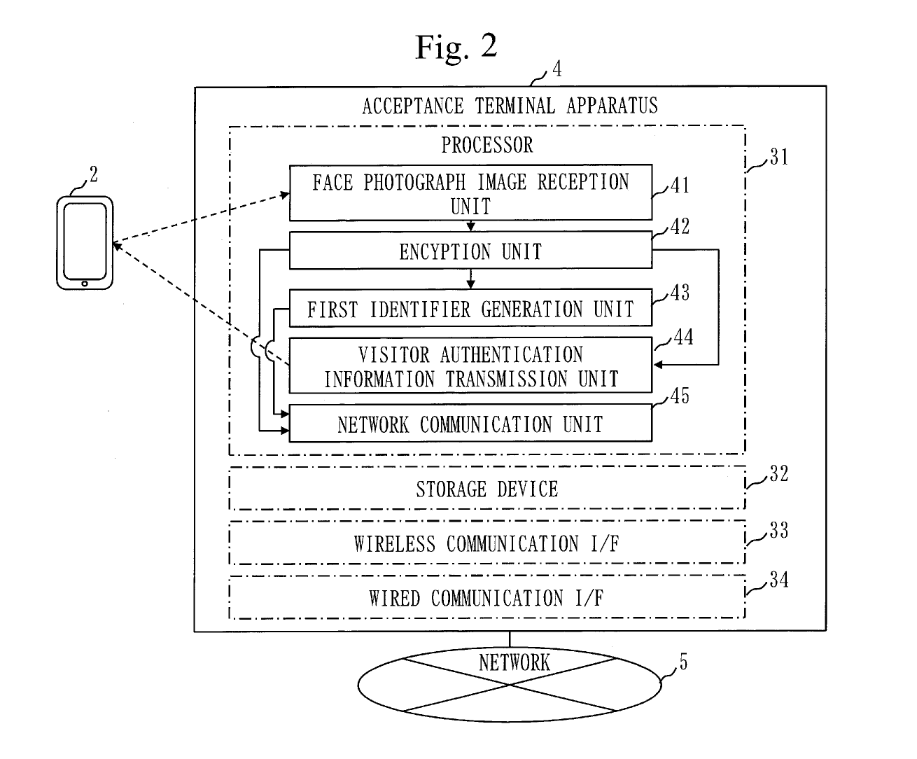

FIG. 2 illustrates an example of a functional configuration of the acceptance terminal apparatus 4.

In FIG. 2, a face photograph image reception unit 41 receives the face photograph image of the prospective visitor 1 from the mobile terminal device 2.

An encryption unit 42 encrypts the face photograph image received by the face photograph image reception unit 41 using the random number to obtain the encrypted face photograph image.

As stated above, in the present embodiment, the encrypted face photograph image is the visiting destination authentication information.

A first identifier generation unit 43 acquires the visitor authentication information, that is, the random number used by the encryption unit 42 for encryption, from the encryption unit 42. Then, the first identifier generation unit 43 generates the first identifier from the acquired random number.

A visitor authentication information transmission unit 44 acquires the random number which is the encryption key, from the encryption unit 42. The visitor authentication information transmission unit 44 transmits the acquired random number as the visitor authentication information to the mobile terminal device 2.

A network communication unit 45 acquires the first identifier from the first identifier generation unit 43. The network communication unit 45 acquires the visiting destination authentication information (the encrypted face photograph image) from the encryption unit 42. The network communication unit 45 transmits the first identifier and the visiting destination authentication information to the server apparatus 6 via the network 5.

The acceptance terminal apparatus 4 includes hardware such as a processor 31, a storage device 32, a wireless communication I/F (Interface) 33, and a wired communication I/F 34.

In the storage device 32, programs implementing the functions of the face photograph image reception unit 41, the encryption unit 42, the first identifier generation unit 43, the visitor authentication information transmission unit 44, and the network communication unit 45 are stored.

Then, the processor 31 executes these programs and performs operations of the face photograph image reception unit 41, the encryption unit 42, the first identifier generation unit 43, the visitor authentication information transmission unit 44, and the network communication unit 45.

FIG. 2 schematically illustrates a state in which the processor 31 executes the programs implementing the functions of the face photograph image reception unit 41, the encryption unit 42, the first identifier generation unit 43, the visitor authentication information transmission unit 44 and the network communication unit 45.

The wireless communication I/F 33 performs wireless communication with the mobile terminal device 2.

The wired communication I/F 34 communicates with the server apparatus 6 via the network 5.

When the acceptance terminal apparatus 4 and the mobile terminal device 2 perform wired communication via, for example, a base station, the wired communication I/F 34 performs wired communication with the mobile terminal device 2, in place of the wireless communication I/F 33.

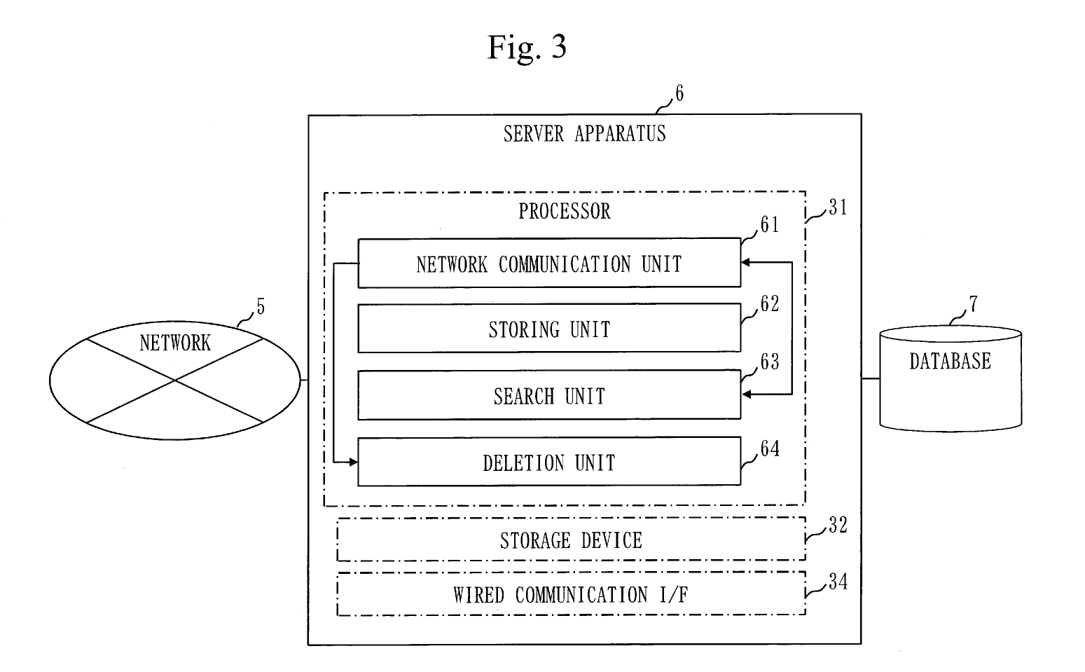

FIG. 3 illustrates an example of a functional configuration of the server apparatus 6.

In FIG. 3, a network communication unit 61 receives the first identifier and the visiting destination authentication information (the encrypted face photograph image) from the acceptance terminal apparatus 4 via the network 5.

Additionally, a network communication unit 61 receives the second identifier from the authentication terminal apparatus 9 via the network 5.

Further, the network communication unit 61 transmits the visiting destination authentication information acquired by a search unit 63 to be described later, to the authentication terminal apparatus 9 via the network 5.

A storing unit 62 acquires the first identifier and the visiting destination authentication information from the network communication unit 61. The storing unit 62 stores the acquired first identifier and the acquired visiting destination authentication information in the database 7 in association with each other.

The search unit 63 searches the database 7 for the visiting destination authentication information.

More specifically, the search unit 63 acquires from the network communication unit 61, the second identifier transmitted from the authentication terminal apparatus 9.

Then, the search unit 63 searches for visiting destination authentication information associated with a first identifier that matches the second identifier.

If the authentication data received by the authentication terminal apparatus 9 is the visitor authentication information, the search unit 63 can acquire from the database 7, the visiting destination authentication information associated with the first identifier that matches the second identifier.

If the search unit 63 has acquired the visiting destination authentication information, the search unit 63 outputs the visiting destination authentication information to the network communication unit 61.

On the other hand, if the authentication data received by the authentication terminal apparatus 9 is not the visitor authentication information, since the second identifier transmitted from the authentication terminal apparatus 9 does not match any of the first identifiers in the database 7, the search unit 63 can not acquire the visiting destination authentication information.

The deletion unit 64 is notified of the visiting destination authentication information to be deleted from the network communication unit 61 and deletes the visiting destination authentication information to be deleted which is stored in the database 7.

The server apparatus 6 includes hardware such as a processor 31, a storage device 32, and a wired communication I/F 34.

In the storage device 32, programs implementing functions of the network communication unit 61, the storing unit 62, search unit 63, and the deletion unit 64 are stored.

The processor 31 executes these programs and performs operations of the network communication unit 61, the storing unit 62, the search unit 63, and the deletion unit 64.

FIG. 3 schematically illustrates a state in which the processor 31 executes the programs implementing the functions of the network communication unit 61, the storing unit 62, the search unit 63, and the deletion unit 64.

The wired communication I/F 34 communicates with the acceptance terminal apparatus 4 and the authentication terminal apparatus 9 via the network 5.

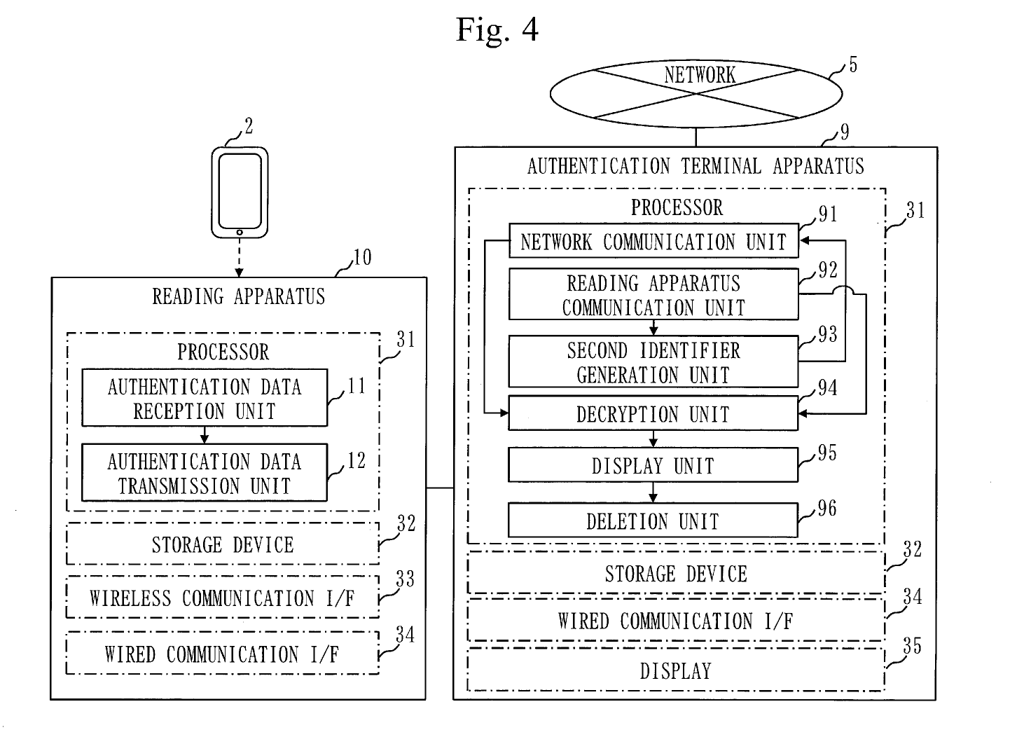

FIG. 4 illustrates an example of a functional configuration of the authentication terminal apparatus 9 and the reading apparatus 10.

In the reading apparatus 10, an authentication data reception unit 11 receives the authentication data from the mobile terminal device 2 when the visitor 1 intends to enter the facility.

An authentication data transmission unit 12 acquires the authentication data from the authentication data reception unit 11 and transmits the acquired authentication data to the authentication terminal apparatus 9.

The reading apparatus 10 includes hardware such as a processor 31, a storage device 32, a wireless communication I/F 33, and a wired communication I/F 34.

In the storage device 32, programs implementing functions of the authentication data reception unit 11 and the authentication data transmission unit 12 are stored.

The processor 31 executes these programs and performs operations of the authentication data reception unit 11 and the authentication data transmission unit 12.

FIG. 4 schematically illustrates a state in which the processor 31 executes the programs implementing the functions of the authentication data reception unit 11 and the authentication data transmission unit 12.

The wireless communication I/F 33 performs wireless communication with the mobile terminal device 2.

The wired communication I/F 34 communicates with the authentication terminal apparatus 9.

In the authentication terminal apparatus 9, a network communication unit 94 acquires the second identifier from a second identifier generation unit 93 to be described later, and transmits the second identifier to the server apparatus 6 via the network 5.

Also, the network communication unit 94 receives the visiting destination authentication information from the server apparatus 6 via the network 5, and outputs the received visiting destination authentication information to a decryption unit 94 to be described later.

A reading apparatus communication unit 92 receives the authentication data from the reading apparatus 10.

Then, the reading apparatus communication unit 92 outputs the authentication data to the second identifier generation unit 93 and the decryption unit 94.

The second identifier generation unit 93 acquires the authentication data from the reading apparatus communication unit 92.

Then, the second identifier generation unit 93 generates the second identifier from the authentication data in the same generation procedure as that of the first identifier.

If the mobile terminal device 2 being a transmitting source of the authentication data, is the same as the mobile terminal device 2 that has transmitted the face photograph image to the acceptance terminal apparatus 4 and has received the visitor authentication information (the random number) from the acceptance terminal apparatus 4, the authentication data is supposed to be the visitor authentication information (the random number).

Since the second identifier generation unit 93 generates the second identifier in the same generation procedure as that of the first identifier, if the authentication data is the visitor authentication information (the random number), the second identifier generated by the second identifier generation unit 93 matches the first identifier.

The second identifier generation unit 93 outputs the generated second identifier to a network communication unit 91.

The decryption unit 94 acquires the visiting destination authentication information from the network communication unit 91. In addition, the decryption unit 94 acquires the authentication data from the reading apparatus communication unit 92.

Then, the decryption unit 94 obtains the face photograph image by a decryption using the visiting destination authentication information acquired by the search unit 63 of the server apparatus 6 and the authentication data which is the visitor authentication information.

Also, the decryption unit 94 outputs the obtained face photograph image to a display unit 95.

The display unit 95 acquires the face photograph image from the decryption unit 94 and displays the acquired face photograph image.

After the display unit 95 displays the face photograph image, the deletion unit 96 deletes the face photograph image from a storage device 32 to be described later.

More specifically, the deletion unit 96 deletes the face photograph image when it is notified from the display unit 95 that the face photograph image is displayed.

Also, the authentication terminal apparatus 9 includes hardware such as a processor 31, a storage device 32, a wired communication I/F 34, and a display 35.

In the storage device 32, programs implementing functions of the network communication unit 91, the reading apparatus communication unit 92, the second identifier generation unit 93, the decryption unit 94, the display unit 95, and the deletion unit 96 are stored.

The processor 31 executes these programs and performs operations of the network communication unit 91, the reading apparatus communication unit 92, the second identifier generation unit 93, the decryption unit 94, the display unit 95, and the deletion unit 96.

FIG. 4 schematically illustrates a state in which the processor 31 executes the programs implementing the functions of the network communication unit 91, the reading apparatus communication unit 92, the second identifier generation unit 93, the decryption unit 94, the display unit 95, and the deletion unit 96.

The storage device 32 stores the authentication data, the second identifier, the encrypted face photograph image, decrypted face photograph image, and the like.

The wired communication I/F 34 communicates with the authentication terminal apparatus 9 and the server apparatus 6.

The display 35 displays the face photograph image of the visitor 1.

Explanation of Operation

(Operation at Registration)

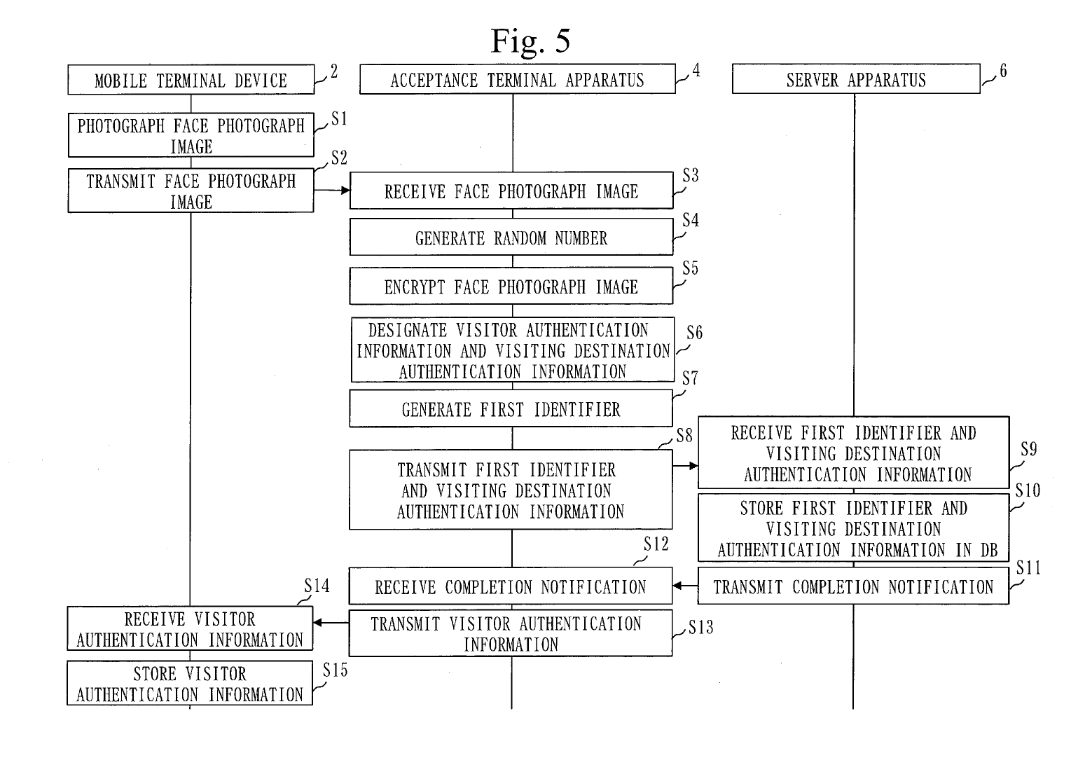

Next, referring to FIG. 5, an operation at a time when the prospective visitor 1 registers information necessary for the face authentication, will be described.

With an operation of the prospective visitor 1, the mobile terminal device 2 photographs the face photograph of the prospective visitor 1 (S1).

Next, the mobile terminal device 2 transmits the photographed face photograph image to the acceptance terminal apparatus 4 of the facility to be visited, via the wireless communication I/F (S2).

The face photograph image transmitted and received between the mobile terminal device 2 and the acceptance terminal apparatus 4 is encrypted by SSL (Secure Sockets Layer), for example.

In the acceptance terminal apparatus 4, the face photograph image reception unit 41 receives the face photograph image of the prospective visitor 1 via the wireless communication I/F 33 (S3).

Next, in the acceptance terminal apparatus 4, the encryption unit 42 generates the random number (S4).

Next, the encryption unit 42 encrypts the face photograph image according to the common key encryption algorithm using the generated random number as the encryption key (S5).

Next, the encryption unit 42 designates the visitor authentication information and the visiting destination authentication information (S6).

In the present embodiment, as described above, the random number used as the encryption key is designated as the visitor authentication information and the encrypted face photograph image is designated as the visiting destination authentication information.

Next, the first identifier generation unit 43 generates the first identifier (S7).

The first identifier generation unit 43 applies, for example, hash functions such as SHA-1 and SHA-2 to the visitor authentication information to generate the first identifier.

Next, the network communication unit 45 transmits the first identifier and the visiting destination authentication information to the server apparatus 6 (S8).

In the server apparatus 6, the network communication unit 61 receives the first identifier and the visiting destination authentication information transmitted from the acceptance terminal apparatus 4 (S9).

Then, the storing unit 62 stores the first identifier and the visiting destination authentication information in the database 7 (S10).

Upon completion of storing the first identifier and the visiting destination authentication information in the database 7, the network communication unit 61 transmits a completion notification to the acceptance terminal apparatus 4 (S11).

In the acceptance terminal apparatus 4, the network communication unit 45 receives the completion notification transmitted from the server apparatus 6 via the wired communication I/F 34 (S12).

Thereafter, the visitor authentication information transmission unit 44 transmits the visitor authentication information to the mobile terminal device 2 (S13).

The mobile terminal device 2 receives the visitor authentication information transmitted from the acceptance terminal apparatus 4 (S14) and stores the visitor authentication information in the mobile terminal device 2 (S15).

(Operation at Authentication)

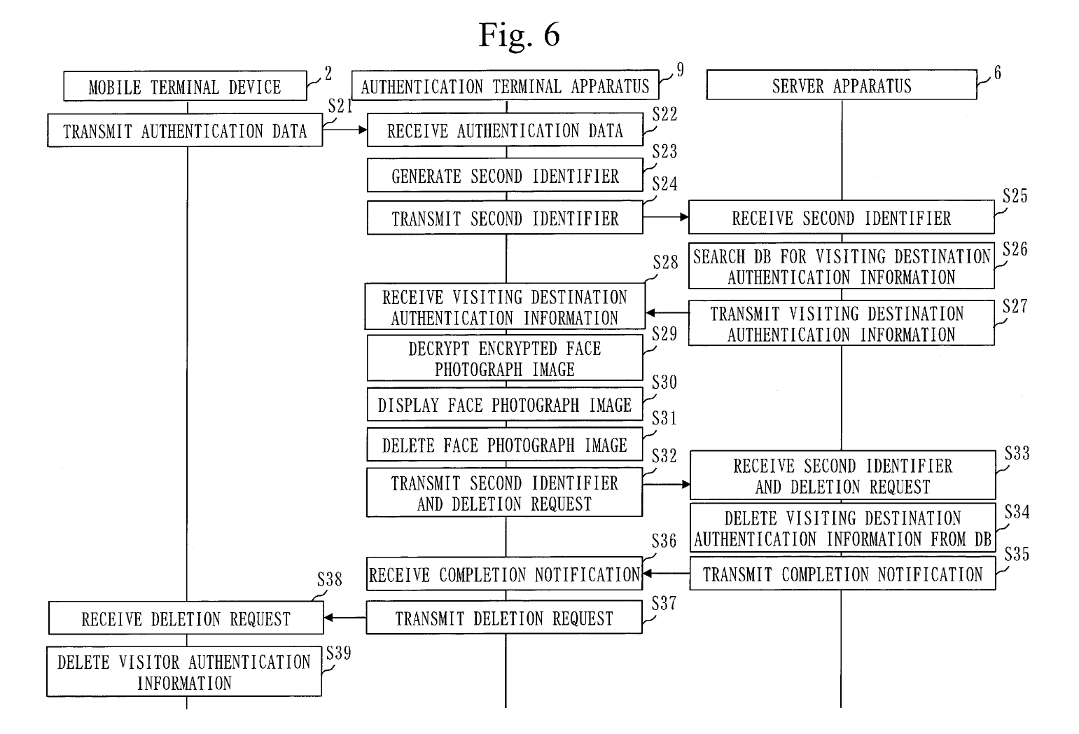

Next, referring to FIG. 6, an authentication process at a time when the visitor 1 visits the facility, will be described.

Note that an operational procedure illustrated in FIG. 6 corresponds to an example of an information processing method and an information processing program.

When the visitor 1 arrives at the entrance of the facility, the visitor 1 holds the mobile terminal device 2 over the reading apparatus 10, then the mobile terminal device 2 transmits the authentication data stored therein to the reading apparatus 10 (S21).

The authentication data reception unit 11 of the reading apparatus 10 receives the authentication data from the mobile terminal device 2. The authentication data transmission unit 12 transmits the authentication data to the authentication terminal apparatus 9. The reading apparatus communication unit 92 of the authentication terminal apparatus 9 receives the authentication data (S22) (authentication data reception process).

As mentioned above, if the visitor 1 whose encrypted face photograph image is registered in the server apparatus 6 visits the facility, the reading apparatus 10 receives the the visitor authentication information as the authentication data from the mobile terminal device 2 of the visitor 1.

Then, the reading apparatus 10 transmits the visitor authentication information as the authentication data to the authentication terminal apparatus 9.

Next, the second identifier generation unit 93 generates the second identifier using a hash function used for generating the first identifier with the authentication data (S23) (second identifier generation process).

Then, the network communication unit 91 transmits the second identifier to the server apparatus 6 (S24).

In the server apparatus 6, the network communication unit 61 receives the second identifier transmitted from the authentication terminal apparatus 9 (S25).

Next, the search unit 63 searches the database 7 for visiting destination authentication information paired with the second identifier (S26) (search process).

For example, the search unit 63 outputs a SQL statement for searching for the visiting destination authentication information paired with the second identifier to the database 7, and receives a search result from the database 7.

When the visiting destination authentication information is obtained, the network communication unit 61 transmits the visiting destination authentication information to the authentication terminal apparatus 9 (S27).

When the visiting destination authentication information is not obtained from the database 7, the network communication unit 91 transmits a message notifying the authentication terminal apparatus 9 that the search failed.

In the authentication terminal apparatus 9, the display unit 95 displays the message, and the guard 8 judges that the authentication has failed.

When the visiting destination authentication information is transmitted from the server apparatus 6, the network communication unit 91 in the authentication terminal apparatus 9 receives the visiting destination authentication information (S28).

In the present embodiment, the visiting destination authentication information is the encrypted face photograph image and the visitor authentication information is the random number. Therefore, the decryption unit 94 decrypts the encrypted face photograph image which is the visiting destination authentication information, according to the common key encryption algorithm, using the visitor authentication information transmitted as the authentication data from the mobile terminal device 2, that is, the random number (S29) (decryption processing).

Then, the display unit 95 displays the face photograph image obtained by the decryption on the display of the authentication terminal apparatus 9 (S30).

Thereafter, the guard 8 performs authentication by comparing the visitor 1 with the face photograph image displayed on the display unit 95.

When the authentication operation is completed, the deletion unit 96 deletes the face photograph image from the authentication terminal apparatus 9 (S31).

Further, the network communication unit 91 transmits to the server apparatus 6, the second identifier and a deletion request requesting to delete the visiting destination authentication information from the database 7 (S32).

In the server apparatus 6, the network communication unit 61 receives a second identifier deletion request transmitted from the authentication terminal apparatus 9 (S33).

Then, the deletion unit 64 deletes the first identifier paired with the second identifier and the visiting destination authentication information associated with the first identifier from the database 7 (S34).

Next, the network communication unit 61 transmits a completion notification notifying that the deletions are completed to the authentication terminal apparatus 9 (S35).

In the authentication terminal apparatus 9, the network communication unit 91 receives the completion notification transmitted from the server apparatus 6 (S36).

In addition, the authentication terminal apparatus 9 transmits a deletion request of the visitor authentication information to the mobile terminal device 2 (S37).

Upon receiving (S38) the deletion request of the visitor authentication information transmitted from the authentication terminal apparatus 9, the mobile terminal device 2 deletes the stored visitor authentication information (S39).

Note that it is acceptable to perform S21 to S31 at a time of entry, also S21 to S39 at a time of exit, and authentication of the visitor at the time of exit.

That is, it is acceptable that the authentication data reception unit 11 of the reading apparatus 10 receives the authentication data from the mobile terminal device 2 of the visitor 1 who intends to exit from the facility, and thereafter authentication is performed using the face photograph image, in a similar way to that at the time of entry.

Explanation of Effect of Embodiment

As described above, in the present embodiment, the face photograph image stored in the database is encrypted, and the encryption key necessary for a decryption is kept in the mobile terminal device by the visitor. Therefore, a person other than the visitor can not decrypt the face photograph image.

Consequently, even if the encrypted face photograph image leaks out from the database, so the third person can not see the face photograph image.

Also, the face photograph is photographed for each visiting opportunity, and the photographed face photograph image is deleted immediately after the visit, so that a storage period of the face photograph image can be shortened.

Further, the visitor himself/herself photographs the face photograph and the photographed face photograph image is encrypted and stored in the database, so that privacy of the visitor can be protected.

Furthermore, only the random number used as the encryption key is kept in the mobile terminal device of the visitor. Therefore, an amount of communication data between the mobile terminal device and the reading apparatus during authentication is small, and a processing load of the mobile terminal device is low.

As a result, even when a mobile terminal device with low processing performance is used, the face authentication according to the present embodiment can be realized.

In addition, since the face photograph photographed for each visiting opportunity is used for authentication, a difference between an appearance of the visitor and the face photograph is small, and the guard can easily perform authentication.

### Second Embodiment

In the first embodiment above, an example of using the random number as the visitor authentication information and using the encrypted face photograph image as the visiting destination authentication information has been described.

The present embodiment describes an example of using the encrypted face photograph image as the visitor authentication information and using the random number as the visiting destination authentication information.

Explanation of Configuration

An example of a configuration of an authentication system according to the present embodiment is as illustrated in FIG. 1.

An example of a functional configuration of an acceptance terminal apparatus 4 according to the present embodiment is as illustrated in FIG. 2.

Also, a functional configuration of a server apparatus 6 according to the present embodiment is as illustrated in FIG. 3.

Further, examples of functional configurations of an authentication terminal apparatus 9 and a reading apparatus 10 according to the present embodiment are as illustrated in FIG. 4.

Explanation of Operation

(Operation at Registration)

First, referring to FIG. 5, an operation when registering information necessary for the face authentication before the prospective visitor 1 visits, will be described.

Steps S1 to S5 in FIG. 5 are the same as those of the first embodiment.

Next, the encrypted face photograph image is designated as the visitor authentication information, and the random number used as the encryption key is designated as the visiting destination authentication information (S6).

Next, the second identifier is generated (S7). The second identifier generation unit 93 generates the second identifier from the encrypted face photograph image.

It is the same as the first embodiment that the second identifier generation unit 93 generates the second identifier using hash functions such as SHA-1 and SHA-2.

S8 to S15 are the same as those of the first embodiment.

(Operation at Authentication)

Next, an authentication process at a time when the visitor 1 visits the facility, will be described with reference to FIG. 6.

S21 to S39 are the same as the first embodiment, except that the encrypted face photograph image is used as the visitor authentication information and the random number is used as the visiting destination authentication information.

Here, S29 will be particularly described.

In the present embodiment, the visiting destination authentication information is the random number and the visitor authentication information is the encrypted face photograph image. Therefore, the decryption unit 94 decrypts the visiting destination authentication information transmitted as the authentication data from the mobile terminal device 2, that is, the encrypted face photograph image, using the random number which is the visitor authentication information (S29).

In the present embodiment as well, as in the first embodiment, it is acceptable to perform S21 to S31 at a time of entry, also S21 to S39 at a time of exit, and authentication of the visitor at the time of exit.

Explanation of Effect of Embodiment

As described above, in the present embodiment, the face photograph image is encrypted and stored in the mobile terminal device of the visitor, and the identifier and the random number are stored in the database.

Therefore, even if data in the database leaks out, the face photograph image is not included in the data leaked out, so the third person can not see the face photograph image.

Further, the visitor himself/herself photographs the face photograph and the face photograph image is not stored in the database. Therefore, privacy of the visitor can be protected.

In addition, as with the first embodiment, since the face photograph photographed for each visiting opportunity is used for authentication, a difference between an appearance of the visitor and the face photograph is small, and the guard can easily perform authentication.

Explanation of Hardware Configuration Example

Finally, hardware configurations of the acceptance terminal apparatus 4, the server apparatus 6, the authentication terminal apparatus 9, and the reading apparatus 10 (hereinafter referred to as “the acceptance terminal apparatus 4 and the like”), are supplementarily explained.

The acceptance terminal apparatus 4 and the like are computers.

The processors 31 illustrated in FIGS. 2 to 4 are ICs (Integrated Circuits) which perform processing.

The processors 31 are, for example, CPUs (Central Processing Units), DSPs (Digital Signal Processors), and GPUs (Graphics Processing Units).

The storage devices 32 are, for example, RAMs (Random Access Memories), ROMs (Read Only Memories), flash memories, HDDs (Hard Disk Drives). The wireless communication I/Fs 33 and the wired communication I/Fs 34 include receivers for receiving data and transmitters for transmitting data.

Each of the wireless communication I/Fs 33 and the wired communication I/Fs 34 is, for example, a communication chip or an NIC (Network Interface Card).

The displays 35 are, for example, LCDs (Liquid Crystal Displays).

An OS (Operating System) is also stored in the storage device 32.

At least a part of the OS is executed by the processor 31.

In FIGS. 2 to 4, one processor 31 is illustrated, however, the acceptance terminal apparatus 4 and the like may have a plurality of processors 31.

Then, the plurality of processors 31 may cooperate to execute the programs realizing the functions of constituent elements (elements denoted by “- - - unit” described in the processors 31 in FIGS. 2 to 4) of the acceptance terminal apparatus 4 and the like.

Information, data, a signal value and a variable value indicating a result of processing of the constituent elements of the acceptance terminal apparatus 4 and the like are stored in the storage device 32 or a register or a cache memory in the processor 31.

Also, the programs that realize the functions of the constituent elements of the acceptance terminal apparatus 4 and the like are stored in storage mediums such as a magnetic disk, a flexible disk, an optical disc, a compact disc, a Blu-ray (registered trademark) disc, a DVD and the like.

The constituent elements of the acceptance terminal apparatus 4 and the like may be provided in “processing circuitry”.

Also, the constituent elements of the acceptance terminal apparatus 4 may be read as “circuits”, “steps”, “procedures”, or “processes”.

The “circuit” and the “processing circuitry” are each a concept including not only the processor 31, but also other types of processing circuits such as a logic IC, a GA (Gate Array), an ASIC (Application Specific Integrated Circuit), or a FPGA (Field-Programmable Gate Array).

### REFERENCE SIGNS LIST

1: visitor, 2: mobile terminal device, 3: acceptance responsible person, 4: acceptance terminal apparatus, 5: network, 6: server apparatus, 7: database, 8: guard, 9: authentication terminal apparatus, 10: reading apparatus, 41: face photograph image reception unit, 42: encryption unit, 43: first identifier generation unit, 44: visitor authentication information transmission unit, 45: network communication unit, 61: network communication unit, 62: storing unit, 63: search unit, 64: deletion unit, 91: network communication unit, 92: reading apparatus communication unit, 93: second identifier generation unit, 94: decryption unit, 95:

display unit, 96: deletion unit, 11: authentication data reception unit, 12: authentication data transmission unit

1. A information processing system which is connected to a database for storing a first identifier and visiting destination authentication information in association with each other, the first identifier being generated from visitor authentication information which is one of an encrypted face photograph image encrypted using key data and the key data, the visiting destination authentication information being the other of the encrypted face photograph image and the key data,
the information processing system comprising
processing circuitry to:
receive authentication data from a visitor terminal apparatus used by a visitor who intends to enter a facility;
generate a second identifier from the authentication data in the same generation procedure as that of the first identifier;
search for visiting destination authentication information associated with the first identifier matching the second identifier, and acquire from the database, the visiting destination authentication information associated with the first identifier matching the second identifier, when the authentication data is the visitor authentication information; and
obtain the face photograph image by a decryption using the visiting destination authentication information acquired and the authentication data being the visitor authentication information.

2. The information processing system according to claim 1, wherein the processing circuitry
receives from a prospective visitor terminal apparatus used by a prospective visitor to the facility, a face photograph image of the prospective visitor;
encrypts the face photograph image received using the key data to obtain the encrypted face photograph image;
generates the first identifier from the visitor authentication information;
stores the visiting destination authentication information and the first identifier in the database in association with each other;
transmits the visitor authentication information to the prospective visitor terminal apparatus; and
acquires from the database, visiting destination authentication information associated with the first identifier matching the second identifier, when the visitor terminal apparatus is the prospective visitor terminal apparatus and the authentication data is the visitor authentication information.

3. The information processing system according to claim 1, wherein
the information processing system is connected to the database which stores the first identifier and the encrypted face photograph image in association with each other, the first identifier being generated from the key data which is the visitor authentication information, the encrypted face photograph image being the visiting destination authentication information,
the processing circuitry
acquires an encrypted face photograph image associated with a first identifier which matches the second identifier from the database, when the authentication data is the key data, and
decrypts the encrypted face photograph image acquired using the authentication data which is the key data to obtain the face photograph image.

4. The information processing system according to claim 1, wherein
the information processing system is connected to the database which stores the first identifier and the key data in association with each other, the first identifier being generated from the encrypted face photograph image which is the visitor authentication information, the key data being the visiting destination authentication information,
the processing circuitry
acquires key data associated with a first identifier which matches the second identifier from the database, when the authentication data is the encrypted face photograph image, and
decrypts the authentication data which is the encrypted face photograph image using the key data acquired to obtain the face photograph image.

5. The information processing system according to claim 1, wherein the processing circuitry:
displays the face photograph image obtained.

6. The information processing system according to claim 5, wherein the processing circuitry:
deletes the face photograph image and deletes the visiting destination authentication information stored in the database, after the face photograph image is displayed.

7. The information processing system according to claim 1, wherein the processing circuitry
receives the authentication data from the visitor terminal apparatus used by the visitor who intends to exit from the facility.

8. A information processing method executed by a computer which is connected to a database for storing a first identifier and visiting destination authentication information in association with each other, the first identifier being generated from visitor authentication information which is one of an encrypted face photograph image encrypted using an encryption key and the encryption key, the visiting destination authentication information being the other of the encrypted face photograph image and the encryption key,
the information processing method comprising:
receiving authentication data from a visitor terminal apparatus used by a visitor who intends to enter a facility;
generating a second identifier from the authentication data in the same generation procedure as that of the first identifier;
searching for visiting destination authentication information associated with the first identifier matching the second identifier and acquiring from the database the visiting destination authentication information associated with the first identifier matching the second identifier, when the authentication data is the visitor authentication information; and
obtaining the face photograph image by a decryption using the visiting destination authentication information acquired from the database and the authentication data being the visitor authentication information.

9. A non-transitory computer readable medium storing a information processing program to cause a computer which is connected to a database for storing a first identifier and visiting destination authentication information in association with each other, the first identifier being generated from visitor authentication information which is one of an encrypted face photograph image encrypted using key data and the key data, the visiting destination authentication information being the other of the encrypted face photograph image and the key data, to execute:
an authentication data reception process to receive authentication data from a visitor terminal apparatus used by a visitor who intends to enter a facility;
a second identifier generation process to generate a second identifier from the authentication data in the same generation procedure as that of the first identifier;
a search process to search for visiting destination authentication information associated with the first identifier matching the second identifier, and acquire from the database, the visiting destination authentication information associated with the first identifier matching the second identifier, when the authentication data is the visitor authentication information; and
a decryption process to obtain the face photograph image by a decryption using the visiting destination authentication information acquired by the search process and the authentication data being the visitor authentication information.
